(19) United States
(12) Patent Application Publication
(10) Pub. No.: US 2009/0254818 A1
(43) Pub. Date: Oct. 8, 2009

(54) METHOD, SYSTEM AND USER INTERFACE FOR PROVIDING INLINE SPELLING ASSISTANCE

(75) Inventors: Frank Jania, Chapel Hill, NC (US); Daniel B. Kehn, Cary, NC (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/062,107

(22) Filed: Apr. 3, 2008

(51) Int. Cl. G06F 17/24

(52) U.S. Cl. 715/257

(57) ABSTRACT

A method for providing inline spelling assistance to a user via a user interface. The method includes receiving at least a prefix of a word being typed by a user, determining whether the word is being misspelled while the user types the word, monitoring a number of times the word is misspelled by the user when it is determined that the word is misspelled, and providing inline spelling assistance by displaying a correct spelling of the word to the user via the user interface based upon a predetermined number of times the user misspells the word, and guiding die user to type the correct spelling of the word.

### BACKGROUND OF THE INVENTION

1. Field of the Invention

This invention relates to a method, system and user interface for providing inline spelling assistance, and particularly to a method, system and user interface which assists a user in spelling words correctly and monitors a users progress over time.

2. Description of Background

There are existing spell check and correcting methods used for checking and correcting spelling in documents via computer systems, either automatically or manually. For example, one method allows a user to check spelling while typing a document or after completion of the document and to correct any misspellings. Another method provides real-time misspelling indicators which notifies the user that a word is being misspelled while the user is typing the word. One disadvantage associated with the existing methods, is that instead of assisting the user in spelling, the user becomes dependent upon the spell check and correcting tools of the system, and therefore, the user is not encouraged to improve his/her spelling abilities. Further, the existing methods do not enable monitoring of a user's spelling progress over time.

### SUMMARY OF THE INVENTION

The shortcomings of the prior art are overcome and additional advantages are provided through the provision of a method for providing inline spelling assistance to a user via a user interface. The method includes receiving at least a prefix of a word being typed by a user, determining whether the word is being misspelled while the user types the word, monitoring a number of times the word is misspelled by the user when it is determined that the word is misspelled, and providing inline spelling assistance by displaying a correct spelling of the word to the user via the user interface based upon a predetermined number of times the user misspells the word, and guiding the user to type the correct spelling of the word.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

Embodiments of the present invention provide inline spelling assistance to a user while the user is typing, and monitors a user's spelling progress over time.

As a result of the summarized invention, technically we have achieved a solution which enables a user to improve his/her spelling abilities over time to thereby eliminate the need for spelling assistance.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart illustrating a method for providing inline spelling assistance to a user via a user interface that can be implemented within embodiments of the present invention.

FIG. 2 is a flowchart illustrating an operation of processing a misspelled word as shown in FIG. 1 that can be implemented within embodiments of the present invention.

FIG. 3 is a schematic block diagram of a general-purpose computer suitable for practicing the present invention embodiments.

### DETAILED DESCRIPTION OF THE INVENTION

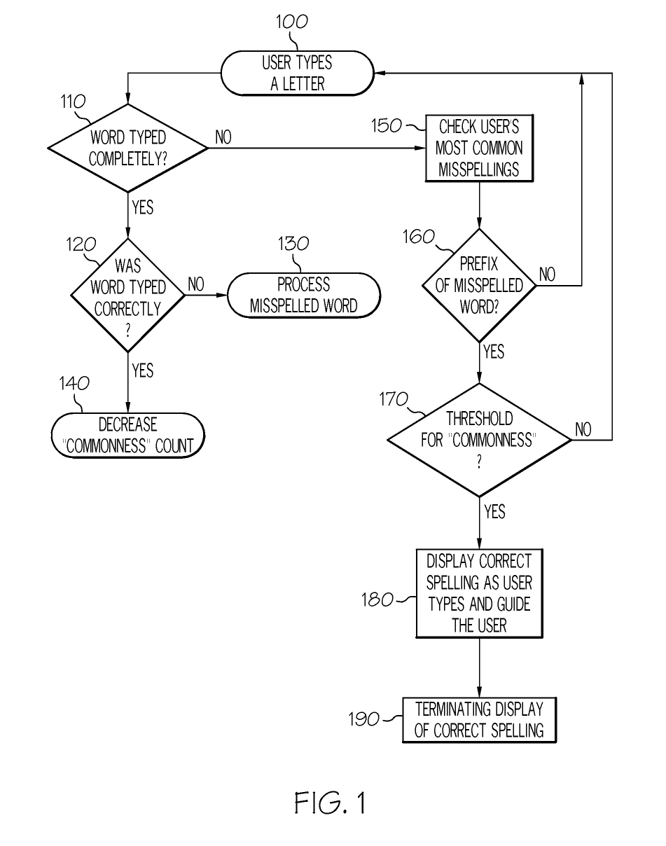

Turning now to the drawings in greater detail, it will be seen that in FIG. 1 there is a flowchart illustrating a method for providing inline spelling assistance to a user via a user interface. According to an exemplary embodiment of the present invention, the method may be implemented via a personal computer (PC), for example, a portable or desktop computer. The present invention is not limited hereto, and maybe implemented in any data processing environment where text entry is being performed.

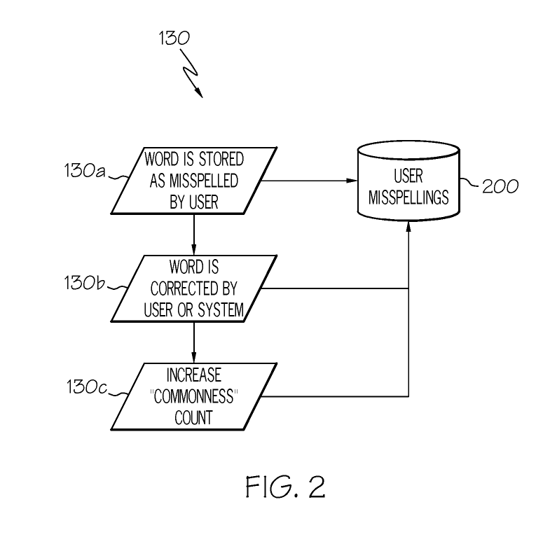

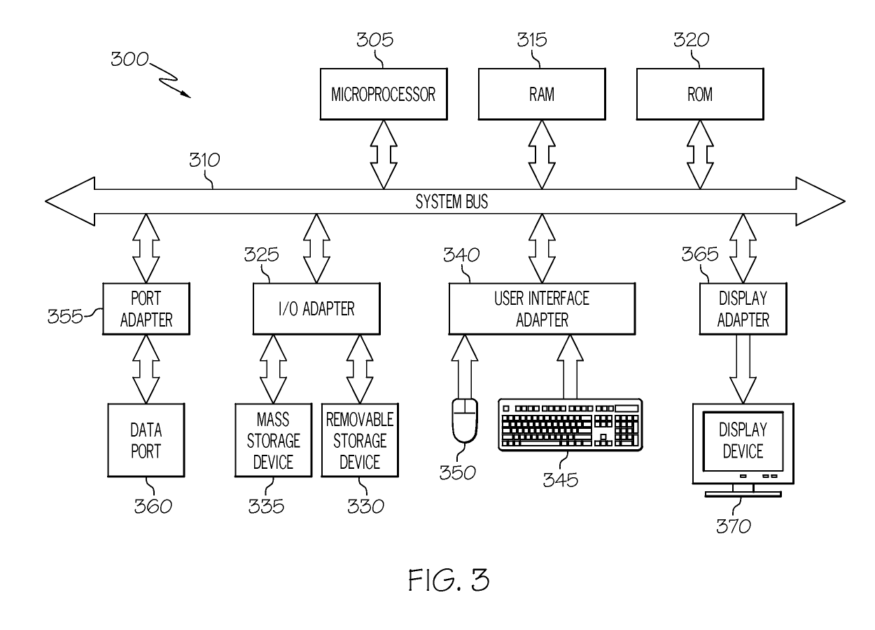

As shown in FIG. 1, the method begins at operation 100, where a user begins typing a word via a computer system (see FIG. 3), for example, and the system receives at least a prefix of the word being typed by the user. According to an exemplary embodiment, a prefix of a word is at least the first two letters of the word, for example. From operation 100, the system determines whether the word is being misspelled while the user types the word by first determining whether the word has been typed completely at operation 110, in the current exemplary embodiment, in order to determine whether the word has been typed completely in operation 110, the system determines whether a space or any non-conjoining punctuation is followed by the word such as a semicolon or a period, for example. That is, if the user types “requested.”, for example, then the system determines that the word “requested” has been typed completely. When it is determined in operation 110 that the word has been typed completely, the process moves to operation 120, where it is determined whether the completed word has been misspelled by the user. When it is determined in operation 120 that the completed word has been spelled correctly, the process moves to operation 140 (to be discussed below). On the other hand when it is determined that the completed word has been misspelled, the process moves to operation 130, where the misspelled word is processed (to be described with reference to FIG. 2). For example, if the user misspells “necessarily” as “nescesarily” then the misspelling of the word is processed as shown in FIG. 2.

FIG. 2 is a flowchart illustrating the operation of processing a misspelled word (operation 130 of FIG. 1) that can be implemented within embodiments of the present invention. As shown in FIG. 2, in operation 130a, the misspelled word is stored in a storage unit 200. According to an exemplary embodiment, the storage unit 200 is not limited to any particular type of storage unit and may vary accordingly. From operation 130a, the process moves to operation 130b, where the user or the system corrects the misspelled word using autocorrect or spell check tools, for example, and a correct spelling of the misspelled word is then associated with the misspelled word and stored in the storage unit 200. For example, the correct spelling of the word “necessarily” is associated, with “nescesarily” and is stored in the storage unit 200. Further, from operation 130b, the process moves to operation 130c, where the system then monitors a number of times the word is misspelled by the user and increases a commonness count by one each time the user misspells the word. According to an exemplary embodiment, the commonness count is a count associated with the number of times the word has been misspelled by the user.

Referring back to FIG. 1, in operation 140, the system further monitors the number of times the word is misspelled by the user by decreasing the commonness count by one in the storage unit each time it is determined in operation 120 that the word has been typed correctly. That is, in the current exemplary embodiment, each time the word “necessarily” is typed correctly, the system decreases the commonness count by one.

According to an exemplary embodiment, the word being typed may be misspelled by the user in different ways each time the user misspells the word. Therefore, the commonness count is associated with the correct, spelling of the word. That is, if the user misspells “necessarily” as “nescesarily”, “necesarily”, and “nessasarily”, for example, the commonness count is increased or decreased based upon a total number of times the word “necessarily” is misspelled. According to an exemplary embodiment, the system keeps track of the different ways the user misspells the word.

When it is determined in operation 110 that the word being typed by the user has not been typed completely, the process moves to operation 150, where the stored misspelled words of the user are checked. From operation 150, the process moves to operation 160, where it is determined whether the prefix, of the word being typed by the user matches a prefix of any of the stored, misspelled words. When it is determined in operation 160 that the prefix of the word being typed by the user matches a prefix of any of the stored misspelled words, the process moves to operation 170, where it is determined whether a threshold for commonness has been reached. For example, when it is determined the prefix “nese” typed by the user matches the prefix of the stored misspelled word “nescesarily”, the process moves to operation 170, and a determination is made as to whether the threshold for commonness has been reached. On the other hand, when it is determined in operation 160 that the prefix of the word being typed by the user does not match a prefix of any of the stored misspelled words, the process returns to operation 100, where the user continues to type the word.

According to an exemplary embodiment, the threshold, for commonness corresponds to a predetermined number of times the user is allowed to misspell the word before a correct spelling of the word is to be displayed to the user via the user interface. Further, according to an exemplary embodiment, the threshold for commonness is user settable or may be set as a system default, for example. That is, the user may set the threshold for commonness to four times, for example, such that if the user misspells the word four times then the correct spelling will be displayed to the user via the user interface. The present invention is not limited to the threshold for commonness being associated to any particular number of times the word is misspelled, and may vary according, to a frequency that the word is being typed or a length of the word plus the frequency, for example.

When it is determined in operation 170 that the threshold for commonness has been reached, the process moves to operation 180 where inline spelling assistance is provided to the user by displaying a correct spelling of the word to the user via the user interface as the user types the word. That is, the correct spelling of the word is displayed to the user via a popup window, for example, based upon a predetermined number of times the user misspells the word, and the system guides the user to type the correct spelling of the word. According to an exemplary embodiment, if based upon the stored misspelled words it is determined that the user begins to misspell more than one word in the same way, the correct spelling of multiple words may be displayed to the user. For example, if the user consistently types “ovb” when attempting to type the word “obvious” or “obviate” the system will display both words to the user via the user interface. The present invention is not limited to the user interlace displaying a particular number of words and may vary, as necessary. According to an exemplary embodiment of the present invention, the user interface is an attentive user interface which manages the user's attention by determining when to interrupt the user and the word(s) to be displayed to the user.

On the other hand, when it is determined in operation 180 that the threshold for commonness has not been reached, the system does not display a correct spelling of the word to the user and the process returns to operation 100 where the user continues typing the word.

According to an exemplary embodiment of the present invention, from operation 180 the process moves to operation 190, where when the user types the word correctly after viewing the correct spelling of the word via the user interlace, the displaying of the correct spelling of the word via the user interface is terminated.

According to another exemplary embodiment, the system may purge the misspelled word from the storage unit 200 after a predetermined time period has passed since the user last misspelled the word.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. This method has the advantage of not requiring a specially designed device or complex software, in order to be implemented.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit, of the invention. For instance, the steps may be performed in a differing order, or steps may be added, deleted or modified. All of these variations are considered a part of the claimed invention.

Generally, the method for providing inline spelling assistance to a user via a user interface described herein is practiced with a general-purpose computer and the method may be coded as a set of instructions on removable or hard media for use by the general-purpose computer. FIG. 3 is a schematic block diagram of a general-purpose computer suitable for practicing the present invention embodiments. In FIG. 3, computer system 300 has at least one microprocessor or central processing unit (CPU) 305. CPU 305 is interconnected via a system bus 310 to a random access memory (RAM) 315, a read-only memory (ROM) 320, an input/output (I/O) adapter 325 for a connecting a removable data and/or program storage device 330 and a mass data and/or program storage device 335, a user interface adapter 340 for connecting a keyboard 345 and a mouse 350, a port, adapter 355 for connecting a data port 360 and a display adapter 365 for connecting a display device 370.

ROM 320 contains the basic operating system for computer system 300. The operating system may alternatively reside in RAM 315 or elsewhere as is known in the art. Examples of removable data and/or program storage device 330 include magnetic media such as floppy drives and tape drives and optical media such as CD ROM drives. Examples of mass data and/or program storage device 335 include hard disk drives and non-volatile memory such as flash memory, in addition to keyboard 345 and mouse 350, other user input devices such as trackballs, writing tablets, pressure pads, microphones, light pens and position-sensing screen displays may be connected to user interface 340. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention, in operation, information for or the computer program created to run the present invention is loaded on the appropriate removable data and/or program storage device 330, fed through data port 360 or typed in using keyboard 345.

In view of the above, the present method embodiment may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

While the preferred embodiment to the invention has been described, it will be understood that those skilled in the art, both, now and in the future, may make various improvements and enhancements which fall within the scope of the claims which follow. These claims should be construed to maintain the proper protection for the invention first described.

1. A method for providing inline spelling assistance to a user via a user interface, the method comprising:
receiving at least a prefix of a word being typed by a user;
determining whether the at least prefix of the word is being misspelled while the user types the word;
monitoring a number of times the word is misspelled by the user when it is determined that the word is misspelled; and
providing inline spelling assistance when it is determined that the at least prefix of the word is misspelled by displaying a correct spelling of the word to the user via the user interface as the user types the word based upon a predetermined number of limes the user misspells the word, and guiding the user to type the correct spelling of the word.

2. The method of claim 1, wherein determining whether the word is being misspelled while the user types the word and monitoring a number of times the word is misspelled comprises:
determining whether the word has been typed completely;
determining whether the completed word has been misspelled by the user; and
storing the misspelled word when it is determined that the word has been misspelled;
correcting the misspelled word and associating a correct spelling of the misspelled word with the misspelled word; and
increasing a commonness count associated with the number of times the word has been misspelled by the user.

3. The method of claim 2, further comprising:
decreasing the commonness count by one each time it is determined that the word has been typed correctly.

4. The method of claim 2, further comprising;
checking misspelled words of the user as stored and determining whether the prefix of the word typed by the user matches a prefix of any of the stored misspelled words, when it is determined that the word has not been typed completely;
determining whether a threshold for commonness has been reached corresponding to a predetermined number of times the user is allowed to misspell the word before a correct spelling of the word is to be displayed to the user; and
displaying the correct spelling of the word via the user interface when it is determined that the threshold for commonness has been reached.

5. The method of claim 4, wherein displaying the correct spelling of the word further comprises:
terminating the displaying of the correct spelling of the word via the user interface when it is determined that the user has typed, the word correctly.
